(19) United States
(12) Patent Application Publication
(10) Pub. No.: US 2025/0282252 A1
(43) Pub. Date: Sep. 11, 2025

(54) CHARGE CONTROL DEVICE

(71) Applicant: TOYOTA JIDOSHA KABUSHIKI KAISHA, Toyota-shi (JP)

(72) Inventor: Sungmin CHO, Tokyo (JP)

(73) Assignee: TOYOTA JIDOSHA KABUSHIKI KAISHA, Toyota-shi (JP)

(21) Appl. No.: 19/050,529

(22) Filed: Feb. 11, 2025

(30) Foreign Application Priority Data
Mar. 5, 2024 (JP) 2024-033243

(51) Int. Cl. B60L 53/67; B60L 53/62; B60L 53/65; B60L 53/66

(52) U.S. Cl. CPC B60L 53/67; B60L 53/62; B60L 53/65; B60L 53/66

(57) ABSTRACT

A charge control device includes: a controller configured to generate a charging plan for a vehicle and outputs the generated charging plan to a charger. The controller is configured to start charging for a plurality of vehicles by outputting a predetermined charging plan for testing to the charger when it is determined that the plurality of vehicles are connected to one charger based on information received from the plurality of vehicles, and identify one of the plurality of vehicles as a vehicle actually connected to the charger based on changes in SOC received from the plurality of vehicles.

The present application claims priority to and incorporates by reference the entire contents of Japanese Patent Application No. 2024-033243 filed in Japan on Mar. 5, 2024.

### BACKGROUND

The present disclosure relates to charge control devices.

WO 2021/033481 A1 discloses a technique for identifying the charging efficiency of a charger connected to a vehicle based on the identification information of the charger, creating a charging plan in consideration of the charging efficiency, and transmitting the charging plan to the vehicle through a network.

### SUMMARY

In the technique disclosed in WO 2021/033481 A, when there is an error in the association between the vehicle and the charger, there is a possibility that can not be charged correctly, there is room for improvement.

There is a need for a charge control device capable of easily and accurately discriminating the state of linkage between the vehicle and the charger.

According to one aspect of the present disclosure, there is provided a charge control device including: a controller configured to generate a charging plan for a vehicle and outputs the generated charging plan to a charger, wherein the controller is configured to start charging for a plurality of vehicles by outputting a predetermined charging plan for testing to the charger when it is determined that the plurality of vehicles are connected to one charger based on information received from the plurality of vehicles, and identify one of the plurality of vehicles as a vehicle actually connected to the charger based on changes in SOC received from the plurality of vehicles.

### BRIEF DESCRIPTION OF THE DRAWINGS

FIG. 1 is a block diagram showing the overall configuration of a charge control system including a charge control device according to an embodiment;

FIG. 2 is a charge control device according to the embodiment is a diagram for explaining a first aspect when it is determined that a plurality of vehicles are connected to one charger;

FIG. 3 is the charge control device according to the embodiment, in the case where it is determined that a plurality of vehicles are connected to one charger is a diagram for explaining the case of performing charging to a plurality of vehicles on the basis of the charging plan for inspection;

FIG. 4 is a charge control device according to the embodiment is a diagram for explaining a second aspect when it is determined that a plurality of vehicles are connected to one charger; and

FIG. 5 is a flowchart showing a flow of a charge control method performed by the charge control device according to the embodiment.

### DETAILED DESCRIPTION

A charge control device according to an embodiment of the present disclosure will be described with reference to the drawings. Components in the following embodiment includes those which can be substituted and easily by those skilled in the art, or those which are substantially the same.

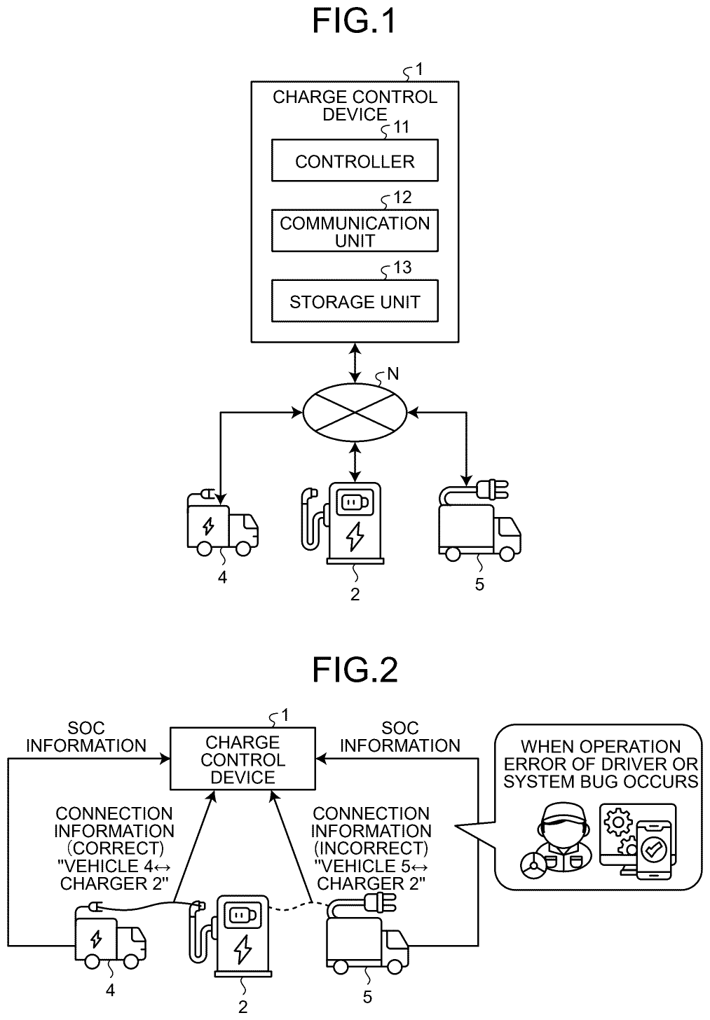

A charge control system including a charge control device according to the embodiment will be described with reference to FIG. 1. The charge control system, as shown in FIG. 1, includes a charge control device 1, a charger 2, and vehicles 4 and 5. The charge control device 1, the charger 2 and the vehicles 4 and 5 are configured to communicate with each other through the network N. The network N is composed of, for example, the Internet, a mobile phone line network or the like.

The charge control device 1 controls the charger 2 for charging the vehicles 4 and 5. The charge control device 1 may be realized by, for example, a cloud or locally disposed workstation, a general-purpose computer such as a personal computer or the like. Further, the charge control device 1 includes a control unit 11, a communication unit 12, and a storage unit 13.

The control unit 11 is realized, for example, by a processor consisting of a central processing unit (CPU) or the like, a memory (main storage unit) consisting of a random access memory (RAM) and a read only memory (ROM) or the like.

The control unit 11 generates a charging plan of the vehicles 4 and 5, and outputs the generated charging plan to the charger 2 (transmit). Moreover, the control unit 11 acquires information about the charger 2 to which each vehicles 4 and 5 is connected from the plurality of vehicles 4 and 5 (hereinafter, referred to as “connection information”). Then, the control unit 11, based on these connection information, determines the vehicle connected to the charger 2, and outputs a charging plan corresponding to the determined vehicle to the charger 2.

The control unit 11 may output to the charger 2 to generate a charging plan after determining the vehicle connected to the charger 2, or may output a charging plan that has been generated in advance to the charger 2. Further, as the charging plan, for example, “since the vehicle arrives at the workplace at 18:00 on the day and departs the workplace at 6:00 on the next day, the vehicle is charged such that a state of charge (SOC) of the vehicle becomes 100% between 18:00 on the day and 6:00 on the next day”, etc.

The communication unit 12 includes, for example, a local area network (LAN) interface board, a wireless communication circuitry for wireless communication, and the like. The communication unit 12 performs communication of various information with the charger 2 and the vehicles 4 and 5 by communication through the network N.

The storage unit 13 consists of a recording medium such as an erasable programmable ROM (EPROM), a hard disk drive (HDD), a removable medium, etc. The removable media includes universal serial bus (USB) memory and a disc recording media such as, for example, a compact disc (CD), a digital versatile disc (DVD), and a blu-ray (BD) disc (registered trademark). Further, the storage unit 13 can store an operating system (OS), various programs, various tables, various databases, etc.

In the storage unit 13, for example, the charging plan and the like of the vehicles 4 and 5, which the control unit 11 has generated, is stored depending on the necessity. Incidentally, the charging plan is generated by a device other than the control unit 11 may be stored in advance in the storage unit 13.

The charger 2 is a device configured to perform charging to the vehicles 4 and 5. For example, the charger 2 is installed in a charging station or a business office or the like. The charger 2, for example, may have only one charging cable, and it may be able to charge only one of the vehicles 4 and 5 at a time.

The vehicles 4 and 5 may be, for example, an electric vehicle such as a plug-in hybrid electric vehicle (PHEV), a battery electric vehicle (BEV) or the like. The vehicles 4 and 5 output, when performing charging by connecting to the charger 2, the connection information relating to the charger 2 to which the own vehicle is connected to the charge control device 1. The connecting information includes information (e.g., ID, etc.) that can specify at least the charger 2 and the vehicles 4 and 5. Further, the vehicles 4 and 5 output the information related to the SOC of the own vehicle to the charge control device 1. Incidentally, the vehicles 4 and 5 may output information about the SOC periodically to the charge control device 1, or may output information about the SOC in response to a request from the charge control device 1.

Here, the connection information relating to the charger 2 to which the vehicles 4 and 5 are connected, for example, is output to the charge control device 1 by the manual operations of the drivers of the vehicles 4 and 5. In this case, for example, the connection information is output to the charge control device 1 in response to the operation of the button or switch or the like installed in the vehicle cabin of the vehicles 4 and 5 by the drivers of the vehicles 4 and 5.

In such a case, for example, as shown in FIG. 2, it is assumed that the connection information indicating the connection to the charger 2 may be output to the charge control device 1 from each of the vehicles 4 and 5 due to the occurrence of an operation error of the driver or system bug. In this case, the control unit 11 that has acquired the connection information from each of the vehicles 4 and 5 determines that a plurality of vehicles 4 and 5 are connected to one charger 2. In the example of FIG. 2 shows a case in which the vehicle 4 is actually connected to the charger 2, while the vehicle 5 is not connected to the charger 2.

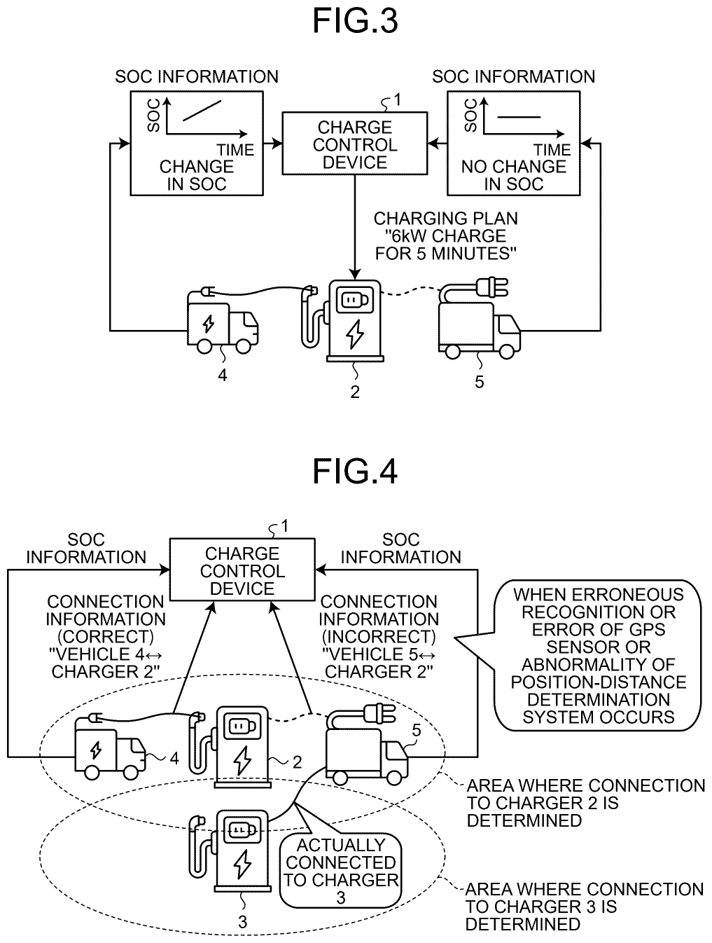

Thus, when it is determined that the plurality of vehicles 4 and 5 are connected to one charger 2, the control unit 11 outputs a predetermined charging plan for testing to the charger 2 as shown in FIG. 3. The charging plan for this test may be, for example, a low-power and short-time charging plan such as “6 kW charge for 5 minutes” and a charging plan such that the SOC of the vehicles 4 and 5 are changed above the error range.

Subsequently, the charger 2 that has acquired the charging plan for testing, for the plurality of vehicles 4 and 5 (actually only the vehicle 4), starts charging based on the charging plan for testing. Subsequently, the control unit 11 acquires the information related to the SOC from the plurality of vehicles 4 and 5, based on the change in the SOC of the vehicles 4 and 5, the charger 2 identifies the vehicle that is actually connected to among the plurality of vehicles 4 and 5.

For example, in FIG. 3, the SOC of the vehicle 4 actually connected to the charger 2 is slightly increased since charging is performed based on the charging plan for testing. On the other hand, in the vehicle 5 which is not connected to the charger 2, since the charge is not performed, naturally SOC does not change. Thus, the control unit 11 identifies the vehicle 4 as a vehicle actually connected to the charger 2, and the control unit 11 outputs a charging plan corresponding to the vehicle 4 to the charger 2 to charge the vehicle 4. On the other hand, the control unit 11 notifies the vehicle 5 which is not connected to the charger 2 that the connection information is erroneous.

In FIG. 2, the example in which the drivers of the vehicles 4 and 5 output, to the charge control device 1, the connection information relating to the charger 2 to which the own vehicles are connected has been explained, the output method of the connection information is not limited thereto. For example, the vehicles 4 and 5 may identify the charger 2 to which the own vehicles are connected based on the position of the own vehicle identified by using the global positioning system (GPS) or the like, or based on the distance or the like between the own vehicle and the charger 2 and output the connection information relating to the identified charger 2 to the charge control device 1.

Even in such cases, for example, as shown in FIG. 4, when the erroneous recognition or error of GPS sensor or abnormality or the like of the position-distance determination system occurs, it is assumed that the connection in formation indicating the connection to the charger 2 from each of the vehicles 4 and 5 is output to the charge control device 1. In the example of FIG. 4, a vehicle actually connected to the charger 2 is the vehicle 4, and the vehicle 5 is connected to another charger 3.

In such a case, the control unit 11 starts charging for the plurality of vehicles 4 and 5, as shown in FIG. 4, by outputting a predetermined charging plan for testing to the charger 2. For example, in FIG. 4, charging is performed based on the charge planning for testing in the vehicle 4 actually connected to the charger 2, the SOC of the vehicle 4 is slightly increased. On the other hand, in the vehicle 5 which is connected to the other charger 3, since the charging is not performed, naturally SOC does not change. Thus, the control unit 11 identifies the vehicle 4 as a vehicle which is actually connected to the charger 2, and outputs a charging plan corresponding to the vehicle 4 to the charger 2 to charge the vehicle 4. On the other hand, the control unit 11 notifies the vehicle 5 which is not connected to the charger 2 that the connection information is erroneous.

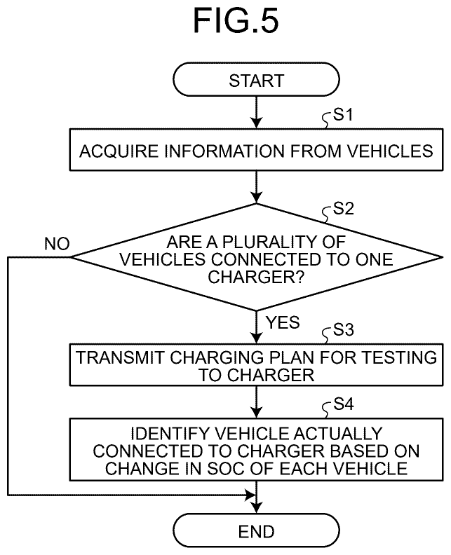

The flow of a charge control method executed by the charge control device according to the embodiment will be described with reference to FIG. 5.

First, the control unit 11 acquires information from the vehicles 4 and 5 (Step S1). The information includes, for example, the connection information indicating the connection to the charger 2, information on SOC of the vehicles 4 and 5, and the like. Subsequently, the control unit 11 determines whether a plurality of vehicles 4 and 5 are connected to one charger 2 based on the connection information indicating the connection to the charger 2 (Step S2).

In Step S2, when it is determined that the plurality of vehicles 4 and 5 is not connected to one charger 2 (Step S2: No), the control unit 11 terminates the process. On the other hand, if it is determined that the plurality of vehicles 4 and 5 are connected to one charger 2 (Step S2: Yes), the control unit 11 transmits a charging plan for testing to the charger 2 (Step S3).

Subsequently, the control unit 11 identifies the vehicle actually connected to the charger 2 based on the change in the SOC of the vehicles 4 and 5 (Step S4), and terminates the present process.

According to the charge control device according to the embodiment described above, when there is a possibility that the plurality of vehicles 4 and 5 are connected to one charger 2, it is possible to easily and accurately determine the state of linkage between the vehicles 4 and 5 and the charger 2 and 3 by performing charging for inspection in each of the vehicles 4 and 5 based on the charging plan for inspection.

That is, with respect to the charger 2 having only one charging cable, if the plurality of vehicles 4 and 5 are determined to be connected at the same time, there is a possibility that the charging is not started without determining the connected vehicle 4 or 5, and notifying the incorrectly determined vehicle 4 or 5.

Therefore, the charge control device 1 according to the embodiment outputs the charging plan for testing to the charger 2 to check the change in SOC of the vehicles 4 and 5. Thus, the charge control device 1 identifies the vehicle in which SOC is increased as a vehicle actually connected to the charger 2, and notifies to the vehicle that is not connected to the charger 2 that the connection information is an error.

According to the present disclosure, it is possible to easily and accurately determine the state of connection between the vehicle and the charger.

Although the disclosure has been described with respect to the specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A charge control device comprising:
a controller configured to generate a charging plan for a vehicle and outputs the generated charging plan to a charger, wherein
the controller is configured to
start charging for a plurality of vehicles by outputting a predetermined charging plan for testing to the charger when it is determined that the plurality of vehicles are connected to one charger based on information received from the plurality of vehicles, and
identify one of the plurality of vehicles as a vehicle actually connected to the charger based on changes in SOC received from the plurality of vehicles.
